(19) United States
(12) Patent Application Publication
(10) Pub. No.: US 2025/0005439 A1
(43) Pub. Date: Jan. 2, 2025

(54) Online Learning with Component Factorized Models

(71) Applicant: Google LLC, Mountain View, CA (US)

(72) Inventors: Julian Paul Grady, Pittsburgh, PA (US); Satyaki Mahalanabis, Sunnyvale, CA (US)

(21) Appl. No.: 18/343,353

(22) Filed: Jun. 28, 2023

(51) Int. Cl. G06N 20/00

(52) U.S. Cl. CPC G06N 20/00

(57) ABSTRACT

Systems and methods for improving accuracy of machine-learning models are described herein. The system can obtain, by one or more computing devices, component data from a donor model. The donor model can be an online model. The component data can have a first embedding. The system can store the component data in a persistent database. The component data can be input data for a plurality of recipient models. The system can receive from the first recipient model of the plurality of recipient models, a first request for the first embedding. The system can transmit, from the persistent database to the first recipient model, the first embedding. The system can process, using the first recipient model, the first embedding to generate a first recipient output.

### FIELD

The present disclosure relates generally to improving performance of machine-learning models by using online learning with component factorized models. More particularly, the present disclosure relates to using component factorization by using a donor (e.g., large) machine-learning model and a plurality of recipients (e.g., small machine-learning models) to improve the performance of the models.

### BACKGROUND

Online machine learning is a method of machine learning in which data becomes available in sequential order and is used to update model parameters, as opposed to batch learning techniques, which generate the model parameters by learning on the entire training data set at once. An online machine learning model is designed to update model parameters, embeddings, and/or component data as new data comes in, rather than being trained once and then used without further learning.

A component factorized model refers to a model where the representation of the data is divided or factorized into different components, each capturing some aspect of the data. The factorization process is also known as representation learning or feature learning, and the goal is to transform the input data into a more useful or efficient representation for a particular task.

### SUMMARY

Aspects and advantages of embodiments of the present disclosure will be set forth in part in the following description, or can be learned from the description, or can be learned through practice of the embodiments.

One example aspect of the present disclosure is directed to a computer-implemented method for improving accuracy of machine-learning models. The method can include obtaining, by one or more computing devices, component data from a donor model. The donor model can be an online model, the component data can have a first embedding. Additionally, the method can include storing the component data in a persistent database. The component data can be input data for a plurality of recipient models. Moreover, the method can include receiving from a first recipient model of the plurality of recipient models, a first request for the first embedding. Furthermore, the method can include transmitting, from the persistent database to the first recipient model, the first embedding. Subsequently, the method can include processing, using the first recipient model, the first embedding to generate a first recipient output.

In some instances, the method can further include receiving, from a second recipient model of the plurality of recipient models, a second request for the first embedding. Additionally, the method can include transmitting, from the persistent database to the second recipient model, the first embedding. Moreover, the method can include processing, using the second recipient model, the first embedding to generate a second recipient output.

In some instances, the first recipient model can predict a clickthrough rate of a content item, and the second recipient model can predict a quality value of a landing page associated with the content item.

In some instances, the second request can be received a period of time after the first request is received. Additionally, a value associated with the first embedding can have changed (e.g., based on real-data received by the donor model) during the period of time that has elapsed between the first request and the second request.

In some instances, the first recipient output can be a predicted Click-Through Rate (pCTR) that calculates the probability that a content item is clicked when the content item is shown to a user.

In some instances, the donor model can be a large model having more than 100 million parameters.

In some instances, the first recipient model can be a small model having less than 100 million parameters.

In some instances, the component data can include embeddings that are not human interpretable, and the first recipient output can be a prediction that is human interpretable.

In some instances, the first embedding can be an embedding that is inputted into the first recipient model to generate the first recipient output.

In some instances, the online model can learn continuously from real-time data being fed into the online model.

In some instances, the donor model can be continuously being trained based on real-time data.

In some instances, the component data can be updated based on real-time data, and the first embedding can be updated based on a change to a user preference that is captured in the real-time data.

In some instances, the plurality of recipient models can be online models, and the first recipient model can generate the recipient output based on real-time data.

In some instances, the first recipient model can serve a prediction based on live internet traffic data.

In some instances, the component data can be model embeddings of the donor model. Additionally, the model embeddings can be continuously transferred to the plurality of recipient models.

In some instances, updates to a model embedding of the first recipient model may not back propagate to the donor model.

Another example aspect of the present disclosure is directed to the computing system. The computing system can include one or more processors. The computing system can include one or more non-transitory computer-readable media that collectively store: a machine-learned donor model that is configured to generate component data; a plurality of machine-learned recipient models that is configured to generate recipient output using the component data; and instructions that, when executed by the one or more processors, cause the computing system to perform operations. The operations can include obtaining component data from a donor model. The donor model can be an online model. The component data can have a first embedding. Additionally, the operations can include storing the component data in a persistent database. The component data can be input data for a plurality of recipient models. Moreover, the operations can include receiving from a first recipient model of the plurality of recipient models, a first request for the first embedding. Furthermore, the operations can include transmitting, from the persistent database to the first recipient model, the first embedding. Subsequently, the operations can include processing, using the first recipient model, the first embedding to generate a first recipient output.

In some instances, the operations can further include receiving, from a second recipient model of the plurality of recipient models, a second request for the first embedding. Additionally, the operations can include transmitting, from the persistent database to the second recipient model, the first embedding. Moreover, the operations can include processing, using the second recipient model, the first embedding to generate a second recipient output.

Another example aspect of the present disclosure is directed to one or more non-transitory computer-readable media that collectively store a donor machine-learned model and a plurality of recipient models. A first recipient model in the plurality of models can generate a first recipient output by performance of operations. The operations can include obtaining component data from the donor model. The donor model can be an online model. The component data can have a first embedding. Additionally, the operations can include storing the component data in a persistent database. The component data can be input data for a plurality of recipient models. Moreover, the operations can include receiving from the first recipient model of the plurality of recipient models, a first request for the first embedding. Furthermore, the operations can include transmitting, from the persistent database to the first recipient model, the first embedding. Subsequently, the operations can include processing, using the first recipient model, the first embedding to generate the first recipient output.

Other aspects of the present disclosure are directed to various systems, apparatuses, non-transitory computer-readable media, user interfaces, and electronic devices.

These and other features, aspects, and advantages of various embodiments of the present disclosure will become better understood with reference to the following description and appended claims. The accompanying drawings, which are incorporated in and constitute a part of this specification, illustrate example embodiments of the present disclosure and, together with the description, serve to explain the related principles.

### BRIEF DESCRIPTION OF THE DRAWINGS

Detailed discussion of embodiments directed to one of ordinary skill in the art is set forth in the specification, which makes reference to the appended figures, in which:

FIG. 1 depicts a block diagram of an example donor model and a plurality of recipient models according to example embodiments of the present disclosure.

FIG. 2 depicts a block diagram of an example system architecture according to example embodiments of the present disclosure.

FIG. 3A depicts a block diagram of an example computing system according to example embodiments of the present disclosure.

FIG. 3B depicts a block diagram of an example computing device according to example embodiments of the present disclosure.

FIG. 3C depicts a block diagram of an example computing according to example embodiments of the present disclosure.

FIG. 4 depicts a flow chart diagram of an example method according to example embodiments of the present disclosure.

FIG. 5 depicts a flow chart diagram of an example method according to example embodiments of the present disclosure.

Reference numerals that are repeated across plural figures are intended to identify the same features in various implementations.

### DETAILED DESCRIPTION

### Overview

Generally, the present disclosure is directed to improving the performance of online machine learning models. According to some embodiments, the techniques described herein can improves the accuracy of a plurality of online machine learning models with a small increase in the total additional computing resource usage by having each of the plurality of small online machine learning models (e.g., plurality of recipient models) share a common large online model (e.g., donor model). The small increase in computing resource usage for the improved accuracy of the system can be additional tensor processing unit (TPU) usage and/or additional central processing unit (CPU) usage. TPU usage can be associated with an artificial intelligence (AI) accelerator application-specific integrated circuit (ASIC) developed for neural network machine learning using TensorFlow software. The plurality of online machine learning models can be referred to as recipient models or recipient models. The common online model can be referred to as a harness model or a donor model. The donor model can be a much larger model than each of the plurality of recipient models. For example, the donor model can be a large model (e.g., with more than 100,000,000 parameters) and the recipient models can be small models (e.g., with less than 100,000,000 parameters, less than 1,000,000 parameters).

The invention described herein can also reduce the cost of training and serving large machine-learned (ML) models (e.g., donor models) in the online continuous training setting. For example, both a first and a second recipient model are able to generate their respective outputs with only a single inference run of the donor model, which drastically saves computing resources. This can be especially useful in situations where there are multiple large ML models operating, such as multiple models providing input signals to an online advertisement auction, because the cost of training new versions of the large models and running inference through them independently in serving mode can be prohibitive. Furthermore, in contrast to the techniques described herein, by not training and sharing a donor model and instead making each recipient model individually larger to get the same accuracy gain would incur a much larger total resource cost, which would be proportional to the number of recipient models.

Moreover, the system can factorize the models to simplify the learning problem, make the model more interpretable, and improve performance. For example, a recommendation system (e.g., advertisement) can utilize matrix factorization, which is a technique where a matrix of user-item interactions is factorized into two lower-rank matrices, representing latent user factors and item factors. These latent factors capture hidden patterns in the data, such as user preferences and item characteristics, which can be used to predict missing user-item interactions and make recommendations using model parameters and/or embeddings.

Furthermore, the system can utilize ML models that are online to provide more accurate predictions. Online ML model is a method of machine learning in which data becomes available in sequential order and is used to update model parameters for future data at each step, as opposed to batch learning techniques, which generate the model parameters by learning on the entire training data set at once.

An online machine learning model can be a model that learns from data continuously, updating the model parameters and component data (e.g., embeddings) as new data comes in. This is in contrast to batch learning, where the model is trained on a fixed set of data all at once. The online machine learning model includes features such as continuous learning, large-scale learning, performing real-time predictions, and an adaptive system.

With regards to continuous learning, in an online learning setting, data is fed to the model as a continuous stream, and the model updates the model parameters incrementally after observing each new example. This allows the model to adapt to new patterns and changes in the data over time.

With regards to large-scale learning (i.e., memory efficiency), online learning is especially useful when the dataset is too large to fit into memory all at once, as the model only needs to store the current example in memory. For example, when the dataset is too large to fit into memory all at once, an online learning algorithm can process the data in smaller chunks.

Additionally, the online machine learning model can make predictions in real-time as the model is continuously updated with new data. Furthermore, the online machine learning model is an adaptive system, such that if the data's underlying distribution can change over time, an online learning model can adapt to these changes. These features make the online machine learning model suitable for applications where timely responses are crucial, such as online recommendations, or adaptive user interfaces.

Examples of online learning algorithms that are utilized in online machine learning models include, but are not limited to, Stochastic Gradient Descent (SGD), Perceptron, and Passive-Aggressive algorithms, online Support Vector Machines (Online SVMs), online versions of boosting, online decision trees, online versions of k-Nearest Neighbors (k-NN).

According to some embodiments, the system can perform continuous online transfer given that both the donor model and the recipient models are online models. The model components generated by the donor model can be continuously transferred to the recipient models. For example, the donor model can generate outputs (e.g., embeddings) for a training example, and the recipient models can continuously consume the generated outputs of the donor model. In conventional systems, which do not use online models, the model embeddings are transferred just one time from the models, or the dependence between the outputs of the models are cut off after a certain period of time.

Technical improvements provided by the invention include continuous transfer so that the improvements remain unchanged during the entire lifetime of the recipient models. In contrast, existing sharing and transfer mechanisms between machine learning models are either one-time only (e.g. parameters and/or embeddings learned by one model are transferred to another at the start of training) or have a cutoff date beyond which the recipient models do not use the outputs of the donor model for training. For these conventional mechanisms, the accuracy improvement of recipients due to transfer diminishes with time after the cutoff. This invention involves continuous transfer, so that the improvements remain unchanged during the entire lifetime of recipient models.

Additionally, technical improvements provided by the invention include an increase in recipient model capacity. This invention adds virtual capacity (e.g., more parameters, more embeddings) to recipient models by feeding them outputs from the donor model. Unlike distillation, this invention adds capacity to recipient models by feeding the embeddings that are output from the donor model to the recipient models. Distillation is a mechanism by which models use the predictions of another shared, larger, and more accurate model as supplemental training labels to improve their accuracy. The extra capacity enables the recipient models to obtain accuracy gains that may not be achievable through distillation. The accuracy gains are better than distillation, because distillation is orthogonal in such that it does not depend on the specific architecture of the model, the particular type of loss function used, the optimization method, and so on. Instead, distillation is a separate process that can be used in combination with these other elements to improve the performance of the model. Distillation is a process that is applied after the initial training of the larger model, and distillation is orthogonal to many of the other decisions made during the training process. Furthermore, distillation is a training-only mechanism while this invention is a training and serving combination.

Moreover, both the donor model and recipient models are online models. Unlike other approaches that stop transfers at some point in training, this invention involves continuously updating the donor model (so it can adapt to non-stationary tasks) and efficiently makes its outputs available to recipient models throughout their lifetimes, providing them with the same accuracy improvements on non-stationary tasks. A non-stationary task refers to a problem where the underlying data distribution changes over time. Non-stationary tasks can be common because online learning models are often used in situations where data is being continuously generated, and the patterns and trends in the data can change. As a result, the model needs to be able to adapt to these changes in order to continue making accurate predictions. For example, in a recommendation system for an online platform, as new content is added, user preferences change, and the platform itself evolves, the model needs to continuously update to reflect these changes, making this a non-stationary task. Online learning algorithms are designed to handle non-stationary tasks by updating the model continuously as new data comes in. This allows them to adapt to changes in the data distribution over time.

Furthermore, the invention provides an efficient mechanism that allows the output of a model on a given example (e.g. an embedding representation) to be written to the same data store that is used for the input training data. These outputs can then be efficiently shared and used as input to many recipient models. For example, both a first and a second recipient model are able to generate their respective outputs with only a single inference run of the donor model, which drastically saves computing resources.

The invention incorporates ML production best practices by enabling the ability to roll back models in the case of data corruption.

This invention provides a specific advantage over conventional multi headed neural networks, such as amortization. A key differentiation from multi-headed approaches is that the intermediate representations (component outputs) from the donor model can be persisted and made available to downstream recipient models that are running in completely separate processes and at different times. Persisting the output of the donor model refers to the process of saving the predictions or results generated by the donor model for future use. Persisting the output of the donor model can be performed by writing the output to a database (e.g., persistent database), a file, or another form of persistent storage. Persisting the output of the donor model can be useful in a variety of situations. For example, the system can save the predictions of the donor model so that they can be used by the recipient models. For example, a donor model might generate personalized recommendations for each user, and these recommendations could be saved in a database so that they can be displayed to the user when they visit a website.

Persisting the output of the donor model has several advantages. In training, persisting with these representations provides the flexibility to determine the set of consumers (e.g., recipient models) at a later date. In some instances, the system may not have to know upfront which recipient models will utilize the donor output as an input. For example, during an experimentation process, model developers can try out hundreds of variations of recipient models using the same donor model. This increases the opportunities for amortization since each of the recipient models still get the cost amortization benefits from reusing the donor outputs. The concept of amortization in machine learning refers to techniques that aim to spread out or share computational cost in order to make the learning process more efficient.

Similarly in serving mode (e.g., inference mode), the representations from the donor model are also made available to recipient models running in separate processes (e.g. using RPCs or some other communication protocol). As previously mentioned, the set of recipient models running in the serving system do not need to be known ahead of time. Thus the recipient models can obtain the output of the donor model, which is stored in a database, as developers run experiments or introduce new recipient models for new use cases.

Furthermore, unlike multi-headed models where the loss from each head is typically back propagated to the shared parameters, in the system described herein the recipient models do not update the shared inputs from the donor.

The systems and methods of the present disclosure provide several technical effects and benefits. Aspects of the present disclosure can provide several technical improvements to machine-learning by providing cost amortization through persistent storage, online transfer from donor model to recipient models, and improved fault tolerance. With regards to cost amortization through persistent storage, the component outputs are trained and generated only once by one large donor model for each training data instance, and then written to persistent storage. Multiple separate recipient models (e.g., not simply a multi-headed model) can then read these component outputs from the storage system when they are independently training, thereby amortizing training cost. With regards to online continuous transfer from donor to recipients, the donor model and the recipient models are all online models, which are continuously being trained. The component outputs are continuously updated and written out for each newly arriving training data instance by the donor model, and each recipient then all reads these updated outputs for each instance. This continuous update and online transfer are key for the system because it enables large accuracy gains. Otherwise the accuracy gains accrued by the recipient model could be limited. Additionally, the persistent storage based transfer delay from donor to recipients is minimal, which results in limited performance degradation. With regards to improved fault tolerance, given that the system uses online continuous transfer through persistent storage, the system can still function when one of the component output or donor model is not working or is missing. Furthermore, the system uses sophisticated state-of-the-art techniques, using the persistent storage, to handle outages and failure scenarios.

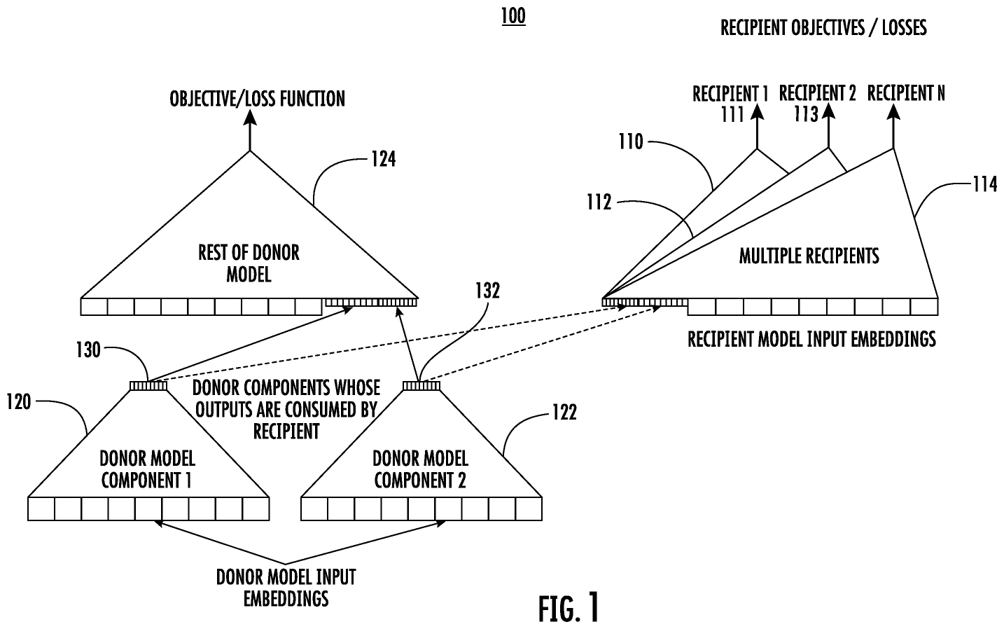

FIG. 1 depicts a block diagram of an example system 100 according to example embodiments of the present disclosure. According to some embodiments, the system 100 can include a model architecture that has a plurality of recipient models 110, 112, 114. Each recipient model can correspond to a different client objective (e.g., objective, task) that the recipient model is trained to perform. For example, a first recipient model 110 can be trained for a first client objective 111, a second recipient model 112 can be trained for a second client objective 113, and so on. These client objectives (e.g., tasks) can either be related or unrelated, and the recipient model can be trained to optimize them either jointly or separately. In the system 100, there is a shared donor model 120 that generates component data 130. The system 100 can input the component data 130 into a recipient model 110 to be processed. The recipient model 110 can be selected from the plurality of recipient models 110, 112, 114 based on a task-specific function or client objective. The donor model 120, which is typically a large model, allows the system 100 to learn representations that are useful across multiple tasks, while the recipient models 110, 112, 114 allow the system to specialize for each individual task. In some instances, the donor model 120 can include a first component donor model 120, a second component donor model 122, and the rest of the donor models 124 that are trained on different objective and/or loss functions.

A donor model 120 can refer to a large model that has a large number of parameters (e.g., more than 100 million parameters, more than 10 million parameters). The donor model 120 can be deep neural networks, which can have millions or even billions of parameters. Examples of donor model 120 can include large-language models (LLMs), such as the BERT model by Google, which has over 100 million parameters. The size of the donor model 120 can be indicative of the capacity of the model and the ability of the model to learn and represent complex patterns in data. The donor model 120 can have a higher capacity than the recipient models 110, 112, 114 and can potentially learn more complex patterns. However, the donor model 120 can require more data to train effectively and can be more prone to overfitting if not trained carefully. The donor model 120 can be computationally intensive to train and require significant amounts of memory.

A recipient model 110, 1112, 114 can be a small machine learning model with fewer parameters (e.g., less than 100 million parameters, less than 1 million, less than 100,000 parameters) compared to a donor model 120. The recipient model 110 can have a lower capacity than the donor model 120, can learn and represent simpler patterns in data, and can be less capable of modeling complex patterns compared to a donor model 120. For instance, a linear regression model or a decision tree with few nodes can be considered a recipient model 110. With regards to neural networks, a recipient model 110 can have a shallow feed-forward network with only one or two hidden layers and relatively few neurons per layer. A recipient model 110 can generally be faster to train and uses less memory than a donor model 120. The recipient model 110 can be trained on a single machine with limited hardware capabilities. The recipient model 110 can be less prone to overfitting, because the recipient model 110 has fewer parameters and can therefore be less likely to overfit the training data. The recipient model 110 can be less likely to learn noise in the data and can be better at generalizing to unseen data, especially when the amount of training data is limited.

In some instances, a donor model 120 may not be the better model for performing a task. According to some embodiments, the system 100 can select a recipient model 110 for a given task based on a variety of factors, including the amount and quality of available data, the complexity of the task, and the computational resources available. The recipient model 110 can be selected from the plurality of recipient models 110, 112, 114 based on a task or client objective 111. In some instances, the recipient model 110 can achieve comparable performance to a large model, particularly when there is limited data, or the task is not complex. Techniques described herein enable using learnt representations from a donor model 120 as input into a recipient model 110 to improve the quality and cost trade off. This invention provides these improved performance and capability in an online and continuous training setting.

In some instances, the donor outputs 130, 132 can be any internal model representation of training examples. The internal model representations can include embeddings (e.g., parameters, representations, model outputs) and may not be human interpretable.

According to some embodiments, given that the models are online models, the system can incorporate real-time data for both the training and serving modes. In the training mode, the system can have recipient models 110, 112, 114 that are receiving updated model parameters from the output of the donor model 120. Additionally, during the serving mode, the recipient models 110, 112, 114 can utilize the output of the donor model 120 during inference. During inference, the recipient models 110, 112, 114 can be served based on live traffic.

Moreover, the plurality of recipient models 110, 112, 114 that are sharing a donor model 120 can be diverse. The recipient models 110, 112, 114 can be performing different learning tasks. For example, a first recipient model 110 can predict clickthrough rate of an ad impression, a second recipient model 112 can predict quality of a landing page associated with an impression, and so on.

According to some embodiments, the system 100 can provide more accurate predictions, such as predicted click-through rate (pCTR), which is a metric used in digital advertising to estimate the probability that a given content item (e.g., advertisement) will be clicked by a user when it is shown an impression. The pCTR is used by ad serving platforms to decide which ads to show to a user, based on their likely interest and the likelihood that they will click on the content item. The pCTR can be the output of a recipient model 110 that has received component data 130 from a donor model 120. The donor model 120 can be trained on historical and real-time click data. The recipient model 110 can take features of the content item and the user (such as the ad content, the user's demographic information, the user's past behavior, etc.) and output a probability that the content item will be clicked. This can then be used to inform decisions about which content item to serve to which users. Predictions of CTR accurately is a challenging problem, because clicks are relatively rare events, and because the context in which content items are shown can vary widely. Nonetheless, even small improvements in pCTR can have a large impact on the efficiency of ad campaigns.

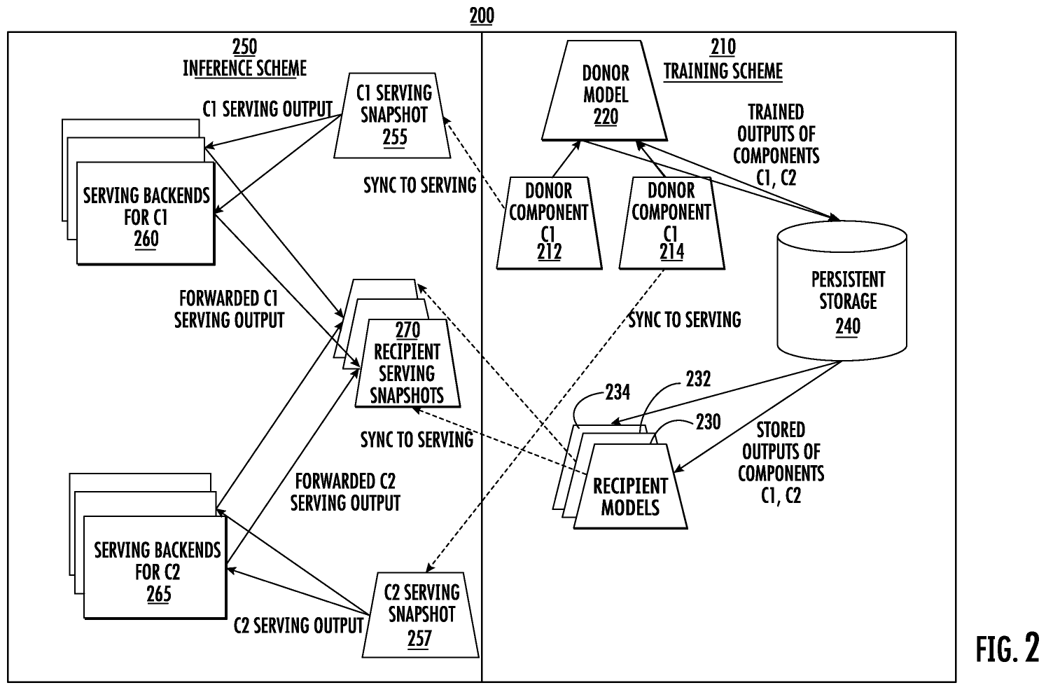

FIG. 2 depicts a block diagram of an example system architecture 200 according to example embodiments of the present disclosure. The right side of the architecture 200 depicts the training scheme 210, and the left side of the architecture depicts the inference scheme 250.

During the training scheme 210, the outputs of the components 212, 214 of a single donor model 220 are consumed by multiple recipient models 230, 232, 234 separately (i.e. a one-to-many setup). The only dependence that the recipient models 230, 232, 234 have on a donor is through the donor's component outputs 212, 214.

Additionally, the training scheme 210 is online and continuous. The donor model 220 updates the components' parameters 212, 214 continuously as training data arrives to the donor model 220. Similarly, the recipient models 230, 232, 234 continuously train and update their own model parameters.

Moreover, the training scheme 210 can include continuous transfer: The outputs of a donor's components 212, 214 as they are being updated are also simultaneously written by the donor to persistent storage 240 for each training data point. Recipient models 230, 232, 234 continuously read these stored component outputs 212, 214 for their own parameter updates as they (separately) train on the corresponding data points.

During the inference scheme 250, the recipient models 230, 232, 234 can sync their snapshots 255, 257 to serve independently from the donor's components. Additionally, the components outputs 212, 214 can be requested by different serving backends 260, 265. These outputs 212, 214 can be finally forwarded as input to multiple recipient model snapshots 270 in the serving flow.

Furthermore, during the inference scheme 250, the fault tolerance of the system (e.g., system 100) can be improved. The system architecture 200 can be built on state-of-the-art machine learning techniques to handle outages and failure scenarios (e.g. “what would happen to recipients if the donor model or component outputs were suddenly missing?”). The system architecture 200 can improve validation, fallback, and rollback performances. With validation, a component syncs a fresh snapshot to serve only if this snapshot's accuracy evaluated on a separate data set is above some threshold. This makes sure that the recipient snapshots serving accuracy will not suffer much even if the component's accuracy is impacted negatively in training. With regards to fallback, the system needs to ensure that recipient models are well behaved (e.g., degrade gracefully) when the donor is not available. The system can use an ablation technique where the component outputs are removed from a small subset of training data for recipient models so that they get to adapt to this scenario, in case the same suddenly happens in serving on a large scale. With regards to rollbacks, the system includes a mitigation strategy when something goes wrong with models in production is to roll them back to a known good state (e.g. a healthy model checkpoint stored on disk). The system design allows us to effectively coordinate rollbacks by tracking the dependencies between recipient and donor models and only rolling back the set of potentially impacted models. After the reason has been debugged and the issue fixed, donor and recipient can seamlessly resume continuous transfer and training.

With reference now to the Figures, example embodiments of the present disclosure will be discussed in further detail.

### Example Devices and Systems

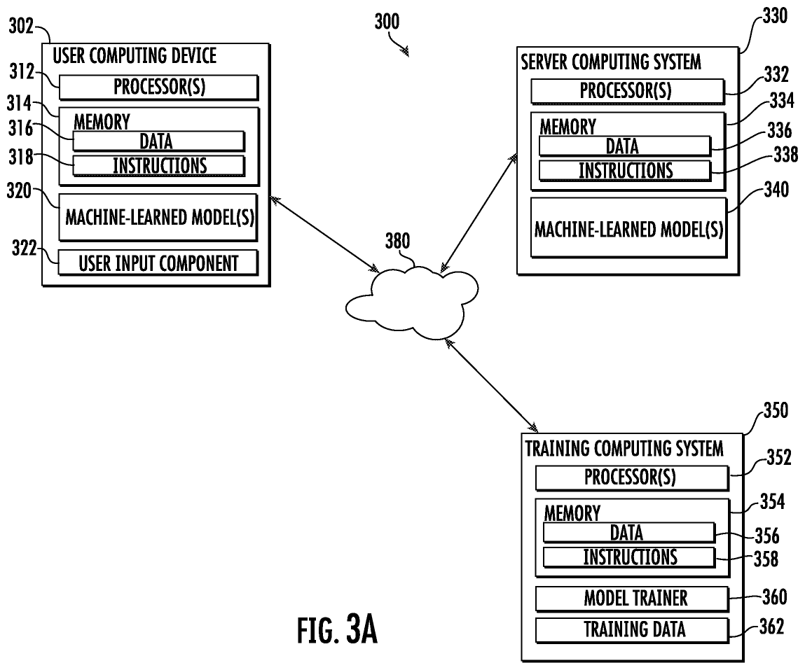

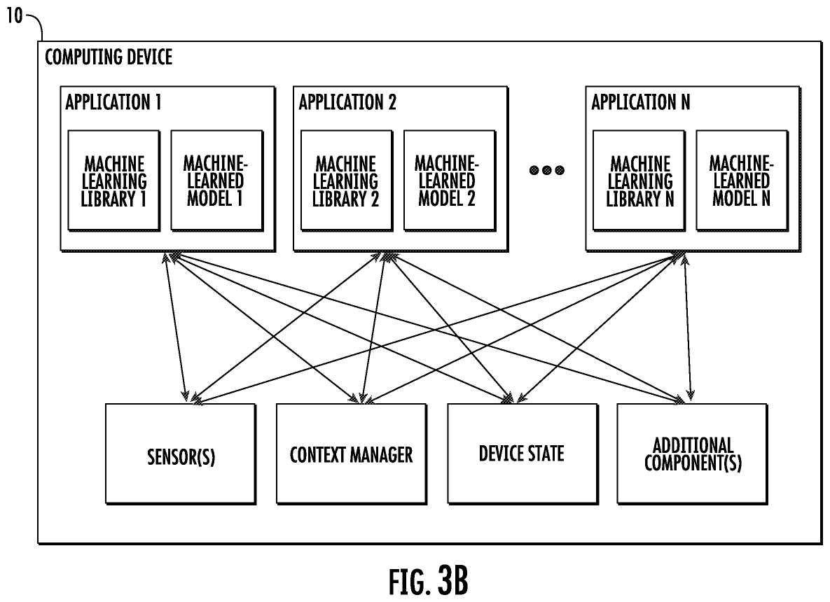

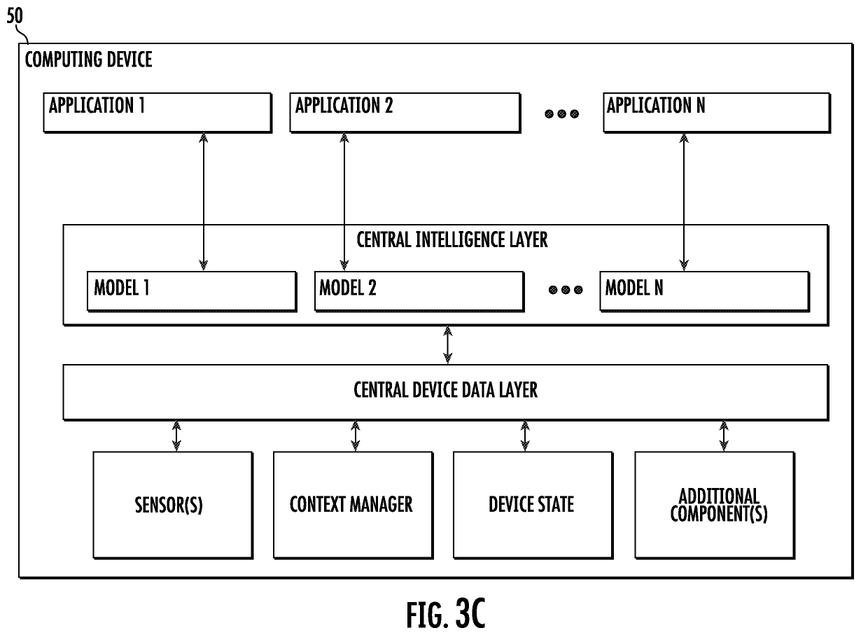

FIG. 3A depicts a block diagram of an example computing system 300 according to example embodiments of the present disclosure. The system 300 includes a user computing device 302, a server computing system 330, and a training computing system 350 that are communicatively coupled over a network 380.

The user computing device 302 can be any type of computing device, such as, for example, a personal computing device (e.g., laptop or desktop), a mobile computing device (e.g., smartphone or tablet), a gaming console or controller, a wearable computing device, an embedded computing device, or any other type of computing device.

The user computing device 302 includes one or more processors 312 and a memory 314. The one or more processors 312 can be any suitable processing device (e.g., a processor core, a microprocessor, an ASIC, an FPGA, a controller, a microcontroller, etc.) and can be one processor or a plurality of processors that are operatively connected. The memory 314 can include one or more non-transitory computer-readable storage media, such as RAM, ROM, EEPROM, EPROM, flash memory devices, magnetic disks, etc., and combinations thereof. The memory 314 can store data 316 and instructions 318 which are executed by the processor 312 to cause the user computing device 302 to perform operations.

In some implementations, the user computing device 302 can store or include one or more models 320. For example, the models 320 can be or can otherwise include various machine-learned models such as neural networks (e.g., deep neural networks) or other types of machine-learned models, including non-linear models and/or linear models. Neural networks can include feed-forward neural networks, recurrent neural networks (e.g., long short-term memory recurrent neural networks), convolutional neural networks or other forms of neural networks. Some example machine-learned models can leverage an attention mechanism such as self-attention. For example, some example machine-learned models can include multi-headed self-attention models (e.g., transformer models). Example models 320 are discussed with reference to FIGS. 1 and 2.

In some implementations, the one or more models 320 can be received from the server computing system 330 over network 380, stored in the user computing device memory 314, and then used or otherwise implemented by the one or more processors 312.

Additionally or alternatively, one or more models 340 can be included in or otherwise stored and implemented by the server computing system 330 that communicates with the user computing device 302 according to a recipient-server relationship. For example, the models 340 can be implemented by the server computing system 340 as a portion of a web service (e.g., an advertisement service). Thus, one or more models 320 can be stored and implemented at the user computing device 302 and/or one or more models 340 can be stored and implemented at the server computing system 330.

The user computing device 302 can also include one or more user input components 322 that receives user input. For example, the user input component 322 can be a touch-sensitive component (e.g., a touch-sensitive display screen or a touch pad) that is sensitive to the touch of a user input object (e.g., a finger or a stylus). The touch-sensitive component can serve to implement a virtual keyboard. Other example user input components include a microphone, a traditional keyboard, or other means by which a user can provide user input.

The server computing system 330 includes one or more processors 332 and a memory 334. The one or more processors 332 can be any suitable processing device (e.g., a processor core, a microprocessor, an ASIC, an FPGA, a controller, a microcontroller, etc.) and can be one processor or a plurality of processors that are operatively connected. The memory 334 can include one or more non-transitory computer-readable storage media, such as RAM, ROM, EEPROM, EPROM, flash memory devices, magnetic disks, etc., and combinations thereof. The memory 334 can store data 336 and instructions 338 which are executed by the processor 332 to cause the server computing system 330 to perform operations.

In some implementations, the server computing system 330 includes or is otherwise implemented by one or more server computing devices. In instances in which the server computing system 330 includes plural server computing devices, such server computing devices can operate according to sequential computing architectures, parallel computing architectures, or some combination thereof.

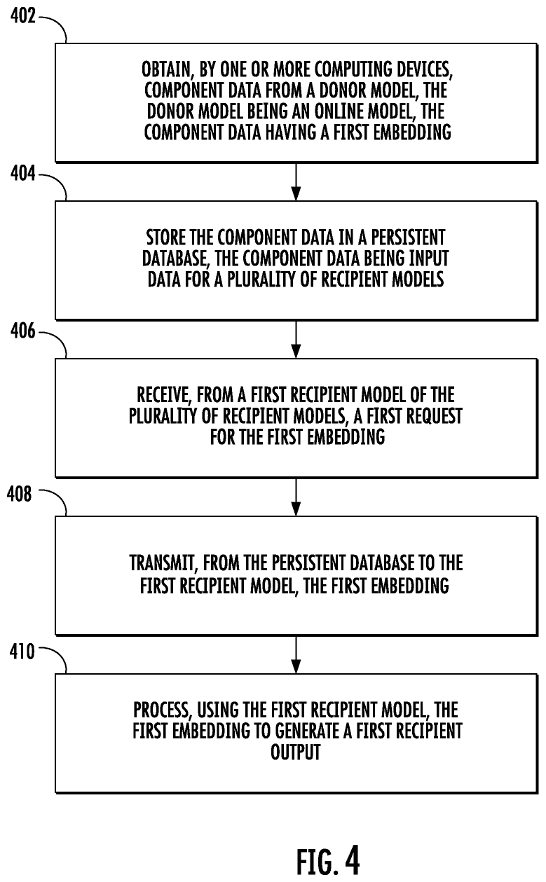

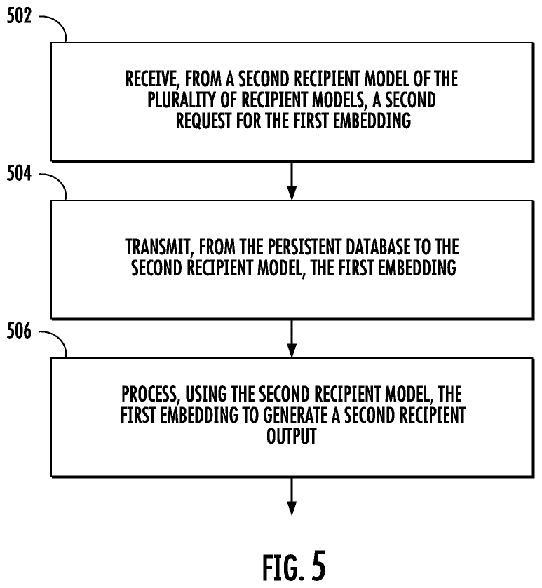

As described above, the server computing system 330 can store or otherwise include one or more models 340. For example, the models 340 can be or can otherwise include various machine-learned models. Example machine-learned models include neural networks or other multi-layer non-linear models. Example neural networks include feed forward neural networks, deep neural networks, recurrent neural networks, and convolutional neural networks. Some example machine-learned models can leverage an attention mechanism such as self-attention. For example, some example machine-learned models can include multi-headed self-attention models (e.g., transformer models). Example models 340 are discussed with reference to FIGS. 4 and 5.

The user computing device 302 and/or the server computing system 330 can train the models 320 and/or 340 via interaction with the training computing system 350 that is communicatively coupled over the network 380. The training computing system 350 can be separate from the server computing system 330 or can be a portion of the server computing system 330.

The training computing system 350 includes one or more processors 352 and a memory 354. The one or more processors 352 can be any suitable processing device (e.g., a processor core, a microprocessor, an ASIC, an FPGA, a controller, a microcontroller, etc.) and can be one processor or a plurality of processors that are operatively connected. The memory 354 can include one or more non-transitory computer-readable storage media, such as RAM, ROM, EEPROM, EPROM, flash memory devices, magnetic disks, etc., and combinations thereof. The memory 354 can store data 356 and instructions 358 which are executed by the processor 352 to cause the training computing system 350 to perform operations. In some implementations, the training computing system 350 includes or is otherwise implemented by one or more server computing devices.

The training computing system 350 can include a model trainer 360 that trains the machine-learned models 320 and/or 340 stored at the user computing device 302 and/or the server computing system 330 using various training or learning techniques, such as, for example, backwards propagation of errors. For example, a loss function can be back propagated through the model(s) to update one or more parameters of the model(s) (e.g., based on a gradient of the loss function). Various loss functions can be used such as mean squared error, likelihood loss, cross entropy loss, hinge loss, and/or various other loss functions. Gradient descent techniques can be used to iteratively update the parameters over a number of training iterations.

In some implementations, performing backwards propagation of errors can include performing truncated backpropagation through time. The model trainer 360 can perform a number of generalization techniques (e.g., weight decays, dropouts, etc.) to improve the generalization capability of the models being trained.

In some implementations, if the user has provided consent, the training examples can be provided by the user computing device 302. Thus, in such implementations, the model 320 provided to the user computing device 302 can be trained by the training computing system 350 on user-specific data received from the user computing device 302. In some instances, this process can be referred to as personalizing the model.

The model trainer 360 includes computer logic utilized to provide desired functionality. The model trainer 360 can be implemented in hardware, firmware, and/or software controlling a general purpose processor. For example, in some implementations, the model trainer 360 includes program files stored on a storage device, loaded into a memory and executed by one or more processors. In other implementations, the model trainer 360 includes one or more sets of computer-executable instructions that are stored in a tangible computer-readable storage medium such as RAM, hard disk, or optical or magnetic media.

The network 380 can be any type of communications network, such as a local area network (e.g., intranet), wide area network (e.g., Internet), or some combination thereof and can include any number of wired or wireless links. In general, communication over the network 380 can be carried via any type of wired and/or wireless connection, using a wide variety of communication protocols (e.g., TCP/IP, HTTP, SMTP, FTP), encodings or formats (e.g., HTML, XML), and/or protection schemes (e.g., VPN, secure HTTP, SSL).

The machine-learned models described in this specification may be used in a variety of tasks, applications, and/or use cases.

In some implementations, the input to the machine-learned model(s) of the present disclosure can be image data. The machine-learned model(s) can process the image data to generate an output. As an example, the machine-learned model(s) can process the image data to generate an image recognition output (e.g., a recognition of the image data, a latent embedding of the image data, an encoded representation of the image data, a hash of the image data, etc.). As another example, the machine-learned model(s) can process the image data to generate an image segmentation output. As another example, the machine-learned model(s) can process the image data to generate an image classification output. As another example, the machine-learned model(s) can process the image data to generate an image data modification output (e.g., an alteration of the image data, etc.). As another example, the machine-learned model(s) can process the image data to generate an encoded image data output (e.g., an encoded and/or compressed representation of the image data, etc.). As another example, the machine-learned model(s) can process the image data to generate an upscaled image data output. As another example, the machine-learned model(s) can process the image data to generate a prediction output.

In some implementations, the input to the machine-learned model(s) of the present disclosure can be text or natural language data. The machine-learned model(s) can process the text or natural language data to generate an output. As an example, the machine-learned model(s) can process the natural language data to generate a language encoding output. As another example, the machine-learned model(s) can process the text or natural language data to generate a latent text embedding output. As another example, the machine-learned model(s) can process the text or natural language data to generate a translation output. As another example, the machine-learned model(s) can process the text or natural language data to generate a classification output. As another example, the machine-learned model(s) can process the text or natural language data to generate a textual segmentation output. As another example, the machine-learned model(s) can process the text or natural language data to generate a semantic intent output. As another example, the machine-learned model(s) can process the text or natural language data to generate an upscaled text or natural language output (e.g., text or natural language data that is higher quality than the input text or natural language, etc.). As another example, the machine-learned model(s) can process the text or natural language data to generate a prediction output.

In some implementations, the input to the machine-learned model(s) of the present disclosure can be speech data. The machine-learned model(s) can process the speech data to generate an output. As an example, the machine-learned model(s) can process the speech data to generate a speech recognition output. As another example, the machine-learned model(s) can process the speech data to generate a speech translation output. As another example, the machine-learned model(s) can process the speech data to generate a latent embedding output. As another example, the machine-learned model(s) can process the speech data to generate an encoded speech output (e.g., an encoded and/or compressed representation of the speech data, etc.). As another example, the machine-learned model(s) can process the speech data to generate an upscaled speech output (e.g., speech data that is higher quality than the input speech data, etc.). As another example, the machine-learned model(s) can process the speech data to generate a textual representation output (e.g., a textual representation of the input speech data, etc.). As another example, the machine-learned model(s) can process the speech data to generate a prediction output.

In some implementations, the input to the machine-learned model(s) of the present disclosure can be latent encoding data (e.g., a latent space representation of an input, etc.). The machine-learned model(s) can process the latent encoding data to generate an output. As an example, the machine-learned model(s) can process the latent encoding data to generate a recognition output. As another example, the machine-learned model(s) can process the latent encoding data to generate a reconstruction output. As another example, the machine-learned model(s) can process the latent encoding data to generate a search output. As another example, the machine-learned model(s) can process the latent encoding data to generate a reclustering output. As another example, the machine-learned model(s) can process the latent encoding data to generate a prediction output.

In some implementations, the input to the machine-learned model(s) of the present disclosure can be statistical data. Statistical data can be, represent, or otherwise include data computed and/or calculated from some other data source. The machine-learned model(s) can process the statistical data to generate an output. As an example, the machine-learned model(s) can process the statistical data to generate a recognition output. As another example, the machine-learned model(s) can process the statistical data to generate a prediction output. As another example, the machine-learned model(s) can process the statistical data to generate a classification output. As another example, the machine-learned model(s) can process the statistical data to generate a segmentation output. As another example, the machine-learned model(s) can process the statistical data to generate a visualization output. As another example, the machine-learned model(s) can process the statistical data to generate a diagnostic output.

In some implementations, the input to the machine-learned model(s) of the present disclosure can be sensor data. The machine-learned model(s) can process the sensor data to generate an output. As an example, the machine-learned model(s) can process the sensor data to generate a recognition output. As another example, the machine-learned model(s) can process the sensor data to generate a prediction output. As another example, the machine-learned model(s) can process the sensor data to generate a classification output. As another example, the machine-learned model(s) can process the sensor data to generate a segmentation output. As another example, the machine-learned model(s) can process the sensor data to generate a visualization output. As another example, the machine-learned model(s) can process the sensor data to generate a diagnostic output. As another example, the machine-learned model(s) can process the sensor data to generate a detection output.

In some cases, the machine-learned model(s) can be configured to perform a task that includes encoding input data for reliable and/or efficient transmission or storage (and/or corresponding decoding). For example, the task may be an audio compression task. The input may include audio data and the output may comprise compressed audio data. In another example, the input includes visual data (e.g. one or more images or videos), the output comprises compressed visual data, and the task is a visual data compression task. In another example, the task may comprise generating an embedding for input data (e.g. input audio or visual data).

In some cases, the input includes visual data, and the task is a computer vision task. In some cases, the input includes pixel data for one or more images and the task is an image processing task. For example, the image processing task can be image classification, where the output is a set of scores, each score corresponding to a different object class and representing the likelihood that the one or more images depict an object belonging to the object class. The image processing task may be object detection, where the image processing output identifies one or more regions in the one or more images and, for each region, a likelihood that region depicts an object of interest. As another example, the image processing task can be image segmentation, where the image processing output defines, for each pixel in the one or more images, a respective likelihood for each category in a predetermined set of categories. For example, the set of categories can be foreground and background. As another example, the set of categories can be object classes. As another example, the image processing task can be depth estimation, where the image processing output defines, for each pixel in the one or more images, a respective depth value. As another example, the image processing task can be motion estimation, where the network input includes multiple images, and the image processing output defines, for each pixel of one of the input images, a motion of the scene depicted at the pixel between the images in the network input.

In some cases, the input includes audio data representing a spoken utterance and the task is a speech recognition task. The output may comprise a text output which is mapped to the spoken utterance. In some cases, the task comprises encrypting or decrypting input data. In some cases, the task comprises a microprocessor performance task, such as branch prediction or memory address translation.

FIG. 3A illustrates one example computing system that can be used to implement the present disclosure. Other computing systems can be used as well. For example, in some implementations, the user computing device 302 can include the model trainer 360 and the training dataset 362. In such implementations, the models 320 can be both trained and used locally at the user computing device 302. In some of such implementations, the user computing device 302 can implement the model trainer 360 to personalize the models 320 based on user-specific data.

FIG. 3B depicts a block diagram of an example computing device 10 that performs according to example embodiments of the present disclosure. The computing device 10 can be a user computing device or a server computing device.

The computing device 10 includes a number of applications (e.g., applications 1 through N). Each application contains its own machine learning library and machine-learned model(s). For example, each application can include a machine-learned model. Example applications include a text messaging application, an email application, a dictation application, a virtual keyboard application, a browser application, etc.

As illustrated in FIG. 3B, each application can communicate with a number of other components of the computing device, such as, for example, one or more sensors, a context manager, a device state component, and/or additional components. In some implementations, each application can communicate with each device component using an API (e.g., a public API). In some implementations, the API used by each application is specific to that application.

FIG. 3C depicts a block diagram of an example computing device 50 that performs according to example embodiments of the present disclosure. The computing device 50 can be a user computing device or a server computing device.

The computing device 50 includes a number of applications (e.g., applications 1 through N). Each application is in communication with a central intelligence layer. Example applications include a text messaging application, an email application, a dictation application, a virtual keyboard application, a browser application, etc. In some implementations, each application can communicate with the central intelligence layer (and model(s) stored therein) using an API (e.g., a common API across all applications).

The central intelligence layer includes a number of machine-learned models. For example, as illustrated in FIG. 3C, a respective machine-learned model can be provided for each application and managed by the central intelligence layer. In other implementations, two or more applications can share a single machine-learned model. For example, in some implementations, the central intelligence layer can provide a single model for all of the applications. In some implementations, the central intelligence layer is included within or otherwise implemented by an operating system of the computing device 50.

The central intelligence layer can communicate with a central device data layer. The central device data layer can be a centralized repository of data for the computing device 50. As illustrated in FIG. 3C, the central device data layer can communicate with a number of other components of the computing device, such as, for example, one or more sensors, a context manager, a device state component, and/or additional components. In some implementations, the central device data layer can communicate with each device component using an API (e.g., a private API).

### Example Methods

FIG. 4 depicts a flow chart diagram of an example method to perform according to example embodiments of the present disclosure. Although FIG. 4 depicts steps performed in a particular order for purposes of illustration and discussion, the methods of the present disclosure are not limited to the particularly illustrated order or arrangement. The various steps of method 400 can be omitted, rearranged, combined, and/or adapted in various ways without deviating from the scope of the present disclosure.

The computing system can be user computing device 302, server computing system 330, training computing system 350, computing device 10, computing device 50. The computing system can use one or more processors (e.g., processor(s) 312, 332, 352) to improve the performance of the machine-learning models.

At 402, a computing system can obtain, by one or more computing devices, component data from a donor model. According to one embodiment, the donor model can be an online model. According to another embodiment, the donor model is an offline model that is trained using batch learning. The component data can have a plurality of embeddings (e.g., a first embedding, a second embedding, a third embedding). For example, the embeddings can be parameters, representations, and/or model outputs.

In one embodiment, the donor model can be a large model having more than 100 million parameters. In another embodiment, the donor model can have more than 10 million parameters. In yet another embodiment, the donor model can be a large model having more than one million parameters. In yet another embodiment, the donor model can be a large model having more than one billion parameters.

In some instances, the online model learns continuously from real-time data being fed into the online model. For example, both the donor model and the plurality of recipient models can be online models.

In some instances, the donor model can be continuously being trained based on real-time data.

In some instances, the component data can be model embeddings of the donor model. Additionally, the model embeddings can be continuously transferred to the plurality of recipient models using the persistent database.

At 404, the computing system can store the component data in a persistent database. The component data can be input data for a plurality of recipient models.

In some instances, the donor model and the plurality of recipient models can be stored as separate model files. For example, the first recipient model can be stored in a first database and the donor model can be stored in a second database that is different and separate from the first database.

In some instances, the donor model and the plurality of recipient models are run in separate processes and at different times. For example, the donor model can be run by a first process at a first time period, and the first recipient model can be run by a second process at a second time period. The second time period being after the first time period.

In some instances, the component data can be updated based on real-time data. When the component data is updated, the system can update the component data that is stored in the persistent database. For example, the first embedding can be updated based on a change to a user preference that is captured in the real-time data, and subsequently, the value associated with the first embedding that is stored in the persistent database can be updated with a new value.

At 406, the computing system can receive from a first recipient model of the plurality of recipient models, a first request for the first embedding. In some instances, the receiving, from a first recipient model of the plurality of recipient models, a first request for the first embedding can include receiving, from the first recipient model, the first request via a remote procedure call (RPC).

In some instances, the first recipient model can be a small model having less than 100 million parameters. In another embodiment, the first recipient model can be a small model having less than 10,000 parameters. In yet another embodiment, the first recipient model can be a small model having less than 100,000 parameters. In yet another embodiment, the first recipient model can be a small model having less than one million parameters.

In some instances, the plurality of recipient models can be online models. Additionally, the first recipient model can generate the first recipient output based on real-time data and the first embedding.

In some instances, the first recipient model can serve a prediction based on live internet traffic data.

At 408, the computing system can transmit, from the persistent database to the first recipient model, the first embedding.

In some instances, the first embedding is an embedding that is inputted into the first recipient model to generate the first recipient output.

At 410, the computing system can process, using the first recipient model, the first embedding to generate a first recipient output. In some instances, the first recipient output can be predicted Click-Through Rate (pCTR) that calculates the probability that a content item is clicked when the content item is shown to a user.

In some instances, the component data obtained at 402 can include embeddings that are not human interpretable, and the first recipient output generated at 410 can include a prediction that is human interpretable.

In some instances, at least the first recipient model is trained separately from the donor model.

In some instances, updates to a model parameter of the first recipient model, such as the first recipient output, may not be back propagated to the donor model.

In some instances, the computing system can periodically re-generate, using the donor model, the component data. Additionally, the computing system can replace the component data in the persistent database with the re-generated component data. For example, the component data is continuously updated and written out for each newly arriving training data instance by the donor model.

FIG. 5 depicts a flow chart diagram of an example method to perform according to example embodiments of the present disclosure. Although FIG. 5 depicts steps performed in a particular order for purposes of illustration and discussion, the methods of the present disclosure are not limited to the particularly illustrated order or arrangement. The various steps of method 500 can be omitted, rearranged, combined, and/or adapted in various ways without deviating from the scope of the present disclosure.

The computing system can be user computing device 302, server computing system 330, training computing system 350, computing device 10, computing device 50. The computing system can use one or more processors (e.g., processor(s) 312, 332, 352) to improve the performance of the machine-learning models.

In some instances, method 500 can be combined with method 400. For example, operation 502 can occur after operation 410.

At 502, a computing system can receive, from a second recipient model of the plurality of recipient models, a second request for the first embedding. For example, the second request can be received from the second recipient model at a different time than the first request is received from the first recipient model. This highlights one of the benefits of persistent database, which enables the embeddings (e.g., output data from the donor model) to be available days or weeks later for any of the recipient models.

In some instances, the first recipient model at 406 can predict a clickthrough rate of a content item, and the second recipient model at 502 can predict a quality value of a landing page associated with the content item.

At 504, the computing system can transmit, from the persistent database to the second recipient model, the first embedding.

At 506, the computing system can process, using the second recipient model, the first embedding to generate a second recipient output.

In some instances, the second request can be received a period of time after the first request is received. Additionally, given that the donor model is an online model that generates component output based on real-time data, a value associated with the first embedding can change during the period of time that has elapsed between receiving the first request and the second request.

The technology discussed herein makes reference to servers, databases, software applications, and other computer-based systems, as well as actions taken, and information sent to and from such systems. The inherent flexibility of computer-based systems allows for a great variety of possible configurations, combinations, and divisions of tasks and functionality between and among components. For instance, processes discussed herein can be implemented using a single device or component or multiple devices or components working in combination. Databases and applications can be implemented on a single system or distributed across multiple systems. Distributed components can operate sequentially or in parallel.

While the present subject matter has been described in detail with respect to various specific example embodiments thereof, each example is provided by way of explanation, not limitation of the disclosure. Those skilled in the art, upon attaining an understanding of the foregoing, can readily produce alterations to, variations of, and equivalents to such embodiments. Accordingly, the subject disclosure does not preclude inclusion of such modifications, variations and/or additions to the present subject matter as would be readily apparent to one of ordinary skill in the art. For instance, features illustrated or described as part of one embodiment can be used with another embodiment to yield a still further embodiment. Thus, it is intended that the present disclosure covers such alterations, variations, and equivalents.

What is claimed is:

1. A computer-implemented method for improving accuracy of machine-learning models, the method comprising:
obtaining, by one or more computing devices, component data from a donor model, the component data having a first embedding;
storing the component data in a persistent database, the component data being input data for a plurality of recipient models;
receiving, from a first recipient model of the plurality of recipient models, a first request for the first embedding;
transmitting, from the persistent database to the first recipient model, the first embedding; and
processing, using the first recipient model, the first embedding to generate a first recipient output.

2. The computer-implemented method of claim 1, the method further comprising:
receiving, from a second recipient model of the plurality of recipient models, a second request for the first embedding, wherein the second request is received from the second recipient model at a different time than the first request is received from the first recipient model;
transmitting, from the persistent database to the second recipient model, the first embedding; and
processing, using the second recipient model, the first embedding to generate a second recipient output.

3. The computer-implemented method of claim 2, wherein the first recipient model predicts a clickthrough rate of a content item, and wherein the second recipient model predicts a quality value of a landing page associated with the content item.

4. The computer-implemented method of claim 2, wherein the second request is received a period of time after the first request is received, and wherein a value associated with the first embedding has changed during the period of time that has elapsed between the first request and the second request.

5. The computer-implemented method of claim 1, wherein the first recipient output is a predicted Click-Through Rate (pCTR) that calculates a probability that a content item is clicked when the content item is shown to a user.

6. The computer-implemented method of claim 1, wherein the donor model is a large model having more than 100 million parameters, and wherein the first recipient model is a small model having less than 100 million parameters.

7. The computer-implemented method of claim 1, wherein the component data includes embeddings that are not human interpretable, and wherein the first recipient output is a prediction that is human interpretable.

8. The computer-implemented method of claim 1, wherein the first embedding is an embedding that is inputted into the first recipient model to generate the first recipient output.

9. The computer-implemented method of claim 1, wherein the donor model is an online model that learns continuously from real-time data being fed into the donor model, and wherein the donor model is continuously being trained based on real-time data.

10. The computer-implemented method of claim 1, wherein the component data is updated based on real-time data, and wherein the first embedding is updated based on a change to a user preference that is captured in the real-time data.

11. The computer-implemented method of claim 1, wherein the plurality of recipient models are online models, and wherein the first recipient model generates the recipient output based on real-time data, and wherein internal model parameters of the first recipient model are updated based on the real-time data.

12. The computer-implemented method of claim 11, wherein updates to the internal model parameters of the first recipient model are not back propagated to the donor model.

13. The computer-implemented method of claim 1, wherein the first recipient model serves a prediction based on live internet traffic data.

14. The computer-implemented method of claim 1, wherein the component data are embeddings that are outputs of the donor model, and wherein the embeddings are continuously transferred to the plurality of recipient models.

15. The computer-implemented method of claim 1, wherein the donor model and the plurality of recipient models are stored as separate model files in different devices.

16. The computer-implemented method of claim 1, wherein the donor model and the plurality of recipient models are run in separate processes and at different times.

17. The computer-implemented method of claim 1, wherein the receiving, from a first recipient model of the plurality of recipient models, a first request for the first embedding includes:
receiving, from the first recipient model, the first request via a remote procedure call (RPC).

18. The computer-implemented method of claim 1, wherein at least the first recipient model is trained separately from the donor model, and wherein the donor model and the first recipient model are trained in different devices.

19. The computer-implemented method of claim 1, further comprising:
periodically re-generating, using the donor model, the component data; and
replacing the component data in the persistent database with the re-generated component data.

20. A computing system, comprising:
one or more processors; and
one or more non-transitory computer-readable media that collectively store:
a machine-learned donor model, wherein the machine-learned donor model is configured to generate component data;
a plurality of machine-learned recipient models, wherein the plurality of machine-learned recipient models is configured to generate recipient output using the component data; and
instructions that, when executed by the one or more processors, cause the computing system to perform operations, the operations comprising:
obtaining component data from a donor model, the component data having a first embedding;
storing the component data in a persistent database, the component data being input data for a plurality of recipient models;
receiving, from a first recipient model of the plurality of recipient models, a first request for the first embedding;
transmitting, from the persistent database to the first recipient model, the first embedding; and
processing, using the first recipient model, the first embedding to generate a first recipient output.

21. The computing system of claim 20, the operations further comprising:
receiving, from a second recipient model of the plurality of recipient models, a second request for the first embedding;
transmitting, from the persistent database to the second recipient model, the first embedding; and
processing, using the second recipient model, the first embedding to generate a second recipient output.

22. One or more non-transitory computer-readable media that collectively store a donor machine-learned model and a plurality of recipient models, wherein a first recipient output is generated by performance of operations, the operations comprising:
obtaining component data from the donor model, the component data having a first embedding;
storing the component data in a persistent database, the component data being input data for a plurality of recipient models;
receiving, from a first recipient model of the plurality of recipient models, a first request for the first embedding;
transmitting, from the persistent database to the first recipient model, the first embedding; and
processing, using the first recipient model, the first embedding to generate the first recipient output.
